(19) United States
(12) Patent Application Publication
(10) Pub. No.: US 2015/0374171 A1
(43) Pub. Date: Dec. 31, 2015

(54) GRILL

(71) Applicant: Rolf Buerkle, Dakota Dunes, SD (US)

(72) Inventor: Rolf Buerkle, Dakota Dunes, SD (US)

(21) Appl. No.: 14/314,039

(22) Filed: Jun. 25, 2014

(51) Int. Cl. A47J 37/07

(52) U.S. Cl. CPC A47J 37/0704

(57) ABSTRACT

Disclosed is an improved grill. The grill comprises a receptacle comprising a pair of extension rods projecting outwardly therefrom, a pair of swivel doors for sealing the receptacle wherein, the inner side of each swivel door comprises an arc surface, a plurality of gear teeth extending outwardly from the arc surface, and an attachment hole for receiving an extension rod therewithin such that, the swivel door, while being secured to the receptacle, rotates about the extension rod. The grill further comprises a slider member vertically slidably secured to the receptacle. The slider member comprises a plurality of slider teeth extending from each side thereof for engaging the gear teeth of a swivel door. The downward movement of the slider member causes the swivel doors to rotate upwards thereby providing access into the receptacle.

### BACKGROUND

### Field of the Invention

The present invention relates to grills that employ hemispherical lids and more particularly to an improved charcoal grill that provides better access thereinto and improves the operational convenience of a user by employing a pair of lighter swivel doors in lieu of a conventional hemispherical lid.

Rounded, compact charcoal grills are one of the most commonly used and commercially successful domestic grilling appliances available today. Kettle grills and Kamado style cooking grills are the examples of grilling appliances that fall in the aforementioned category wherein, a kettle grill is a substantially rounded structure whereas, a Kamado grill is egg-shaped. These grills basically comprise a receptacle for receiving charcoal, a charcoal grill and a cooking grill in that order wherein, food received on top of the cooking grill is cooked either by direct or indirect exposure to fire. The grills further comprise a hinged, upwardly openable substantially hemispherical lid for sealing receptacle when cooking or during storage. One of the major drawbacks of these conventional grills is the hemispherical lid which requires unnecessary effort on the part of the user to handle it; unnecessary because, a better lid design in lieu of the conventional hemispherical lid could have been an easy possibility with all the technological advancement at one's disposal. Further, heavier hemispherical lids only make the usage thereof worse. Further, the horizontal opening of a conventional grill poses another problem for the user as arranging grills within the horizontal opening is quite a task. A grill that improves on the aforementioned aspects of conventional grills is very much welcome in the art.

### SUMMARY

The present invention comprises an improved grill comprising an oblique opening, which considerably improves the convenience of handling the contents therewithin such as, the arranging the grills, replenishing the charcoal, etc. A pair of relatively shorter extension rods extends from the top portion of the rim of the opening wherein, a pair of swivel doors is rotably coupled to the extension rods such that, the swivel doors rotate about an oblique plane parallel to the opening. Each of the swivel doors comprise a plurality of gear teeth extending from an arc surface wherein, the gear teeth are adapted to mesh with slider teeth extending from either side of an elongate spring-loaded slider member, which is slidably disposed between the pair of extension rods. Notably, the slider member is downwardly biased. In order to open the snap-shut swivel doors, initially, the slider member is pressed downwards so as to cause the swivel doors to urge out of the snap-lock. Once past the snap-lock, the slider member, by virtue of being spring-loaded, by overcoming the weight of the swivel doors and the friction between the swivel doors and extension rods, slides downwards causing the swivel doors to swivel open.

Other objects and advantages of the embodiments herein will become readily apparent from the following detailed description taken in conjunction with the accompanying drawings.

### BRIEF DESCRIPTION OF THE DRAWINGS

FIG. 1, according to an embodiment of the present invention, is an illustration of a perspective view of the closed grill.

FIG. 2, according to an embodiment of the present invention, is an illustration of a perspective view of the open grill.

FIG. 3, according to an embodiment of the present invention, is an illustration of a perspective view of the receptacle.

FIG. 4, according to an embodiment of the present invention, is an illustration of the front view of the receptacle.

FIG. 5, according to an embodiment of the present invention, is an illustration of a side view of the receptacle.

FIG. 6, according to an embodiment of the present invention, is an illustration of a side view of the receptacle depicting the angle between the opening and the extension rods.

FIG. 7, according to an embodiment of the present invention, is an illustration of the front perspective view of the swivel door.

FIG. 8, according to an embodiment of the present invention, is an illustration of the rear perspective view of the swivel door.

FIG. 9, according to an embodiment of the present invention, is an illustration depicting a closer view of the arc surface of a swivel door.

FIG. 10, according to an embodiment of the present invention, is an illustration of a perspective view of the slider member.

FIG. 11, according to an embodiment of the present invention, is an illustration of the front view of the slider member.

FIG. 12, according to an embodiment of the present invention, is an illustration depicting the meshing between the slider teeth and the gear teeth.

FIGS. 13A through 13C, according to an embodiment of the present invention, are sequential illustrations involved in opening the grill.

FIGS. 14A through 14C, according to an embodiment of the present invention, are sequential illustrations involved in sealing the grill.

### FIGURES—REFERENCE NUMERALS

10—Grill
12—Receptacle
14—Swivel Door
16—Slider Member
18—Extension Rod
20—Gear Tooth
22—Attachment Hole
24—Slider Tooth

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

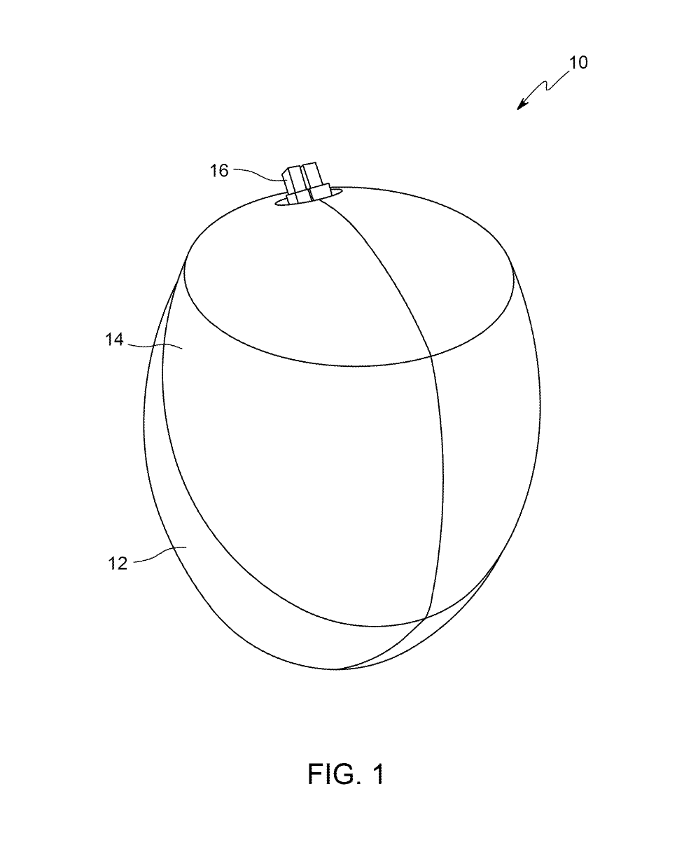

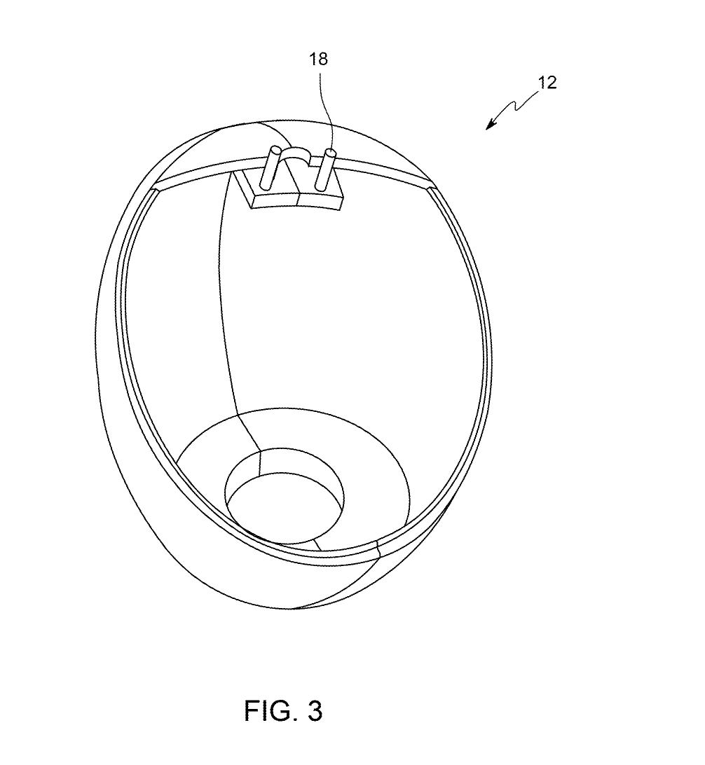

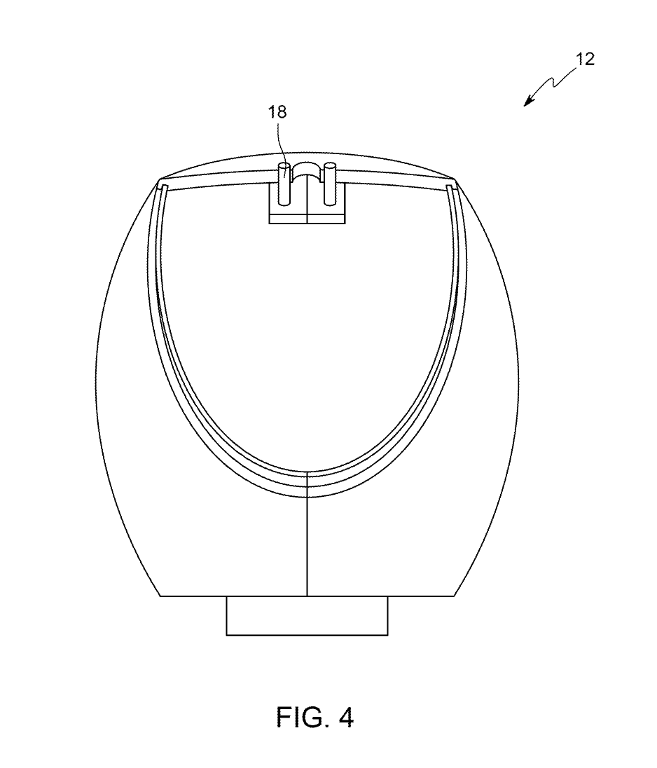

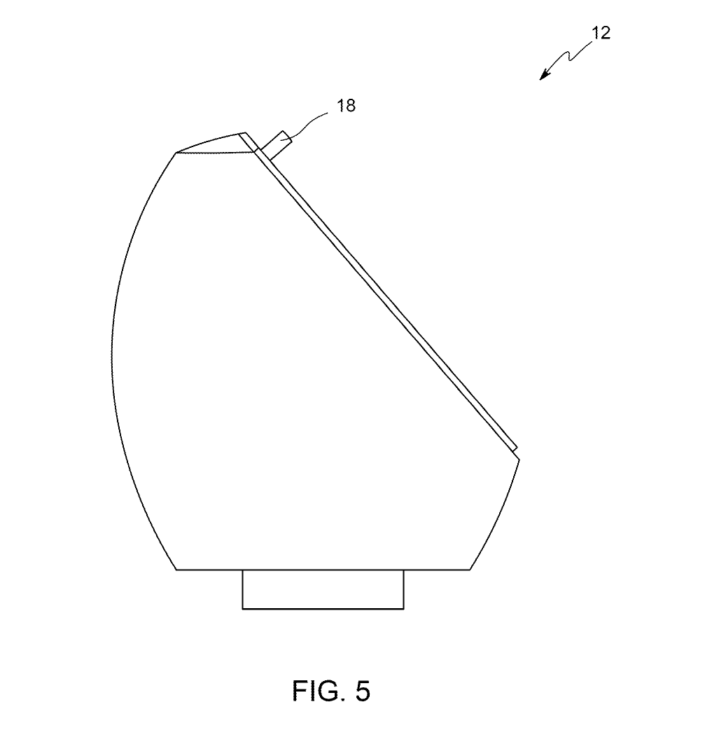

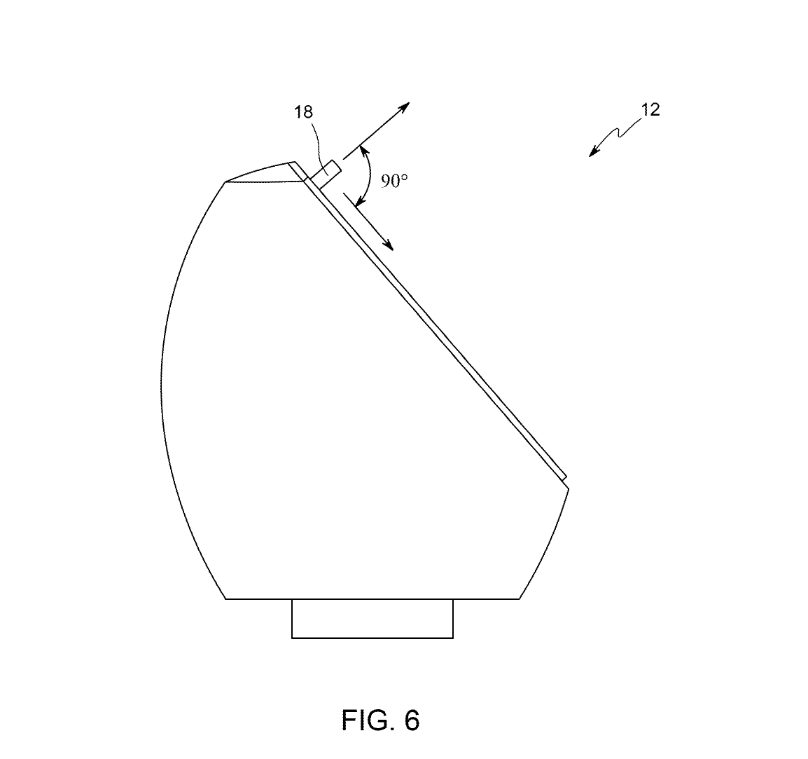

The present invention comprises a grill designed to improve the convenience associated with the usage thereof. Referring to FIGS. 1 through 6, the grill 10 basically is a round structure comprising an open receptacle 12, a pair of swivel doors 14, and a slider member 16. The receptacle 12 comprises a round structure adapted for receiving charcoal, charcoal grill, and a cooking grill therewithin. The opening of the receptacle 12 is obliquely oriented so as improve the user experience of accessing and arranging the contents within the receptacle 12. More particularly, the opening is preferably at an angle of 45 degrees with respect to the horizontal (and the vertical). Notably, the opening is substantially elliptical in shape. The rim of the receptacle 12 is lined with a lining material, the utility of which will become apparent from the following body of text. The receptacle 12 further comprises a pair of relatively shorter extension rods 18 extending from the top portion of the rim such that, each extension rod 18 is perpendicular to the oblique plane of the opening of the receptacle 12 as seen in FIG. 6. The utility of the extension rods 18 will become apparent from the following body of text. Further, a vent is provided on the receptacle 12 for ventilation and for the expulsion of ash, debris, etc.

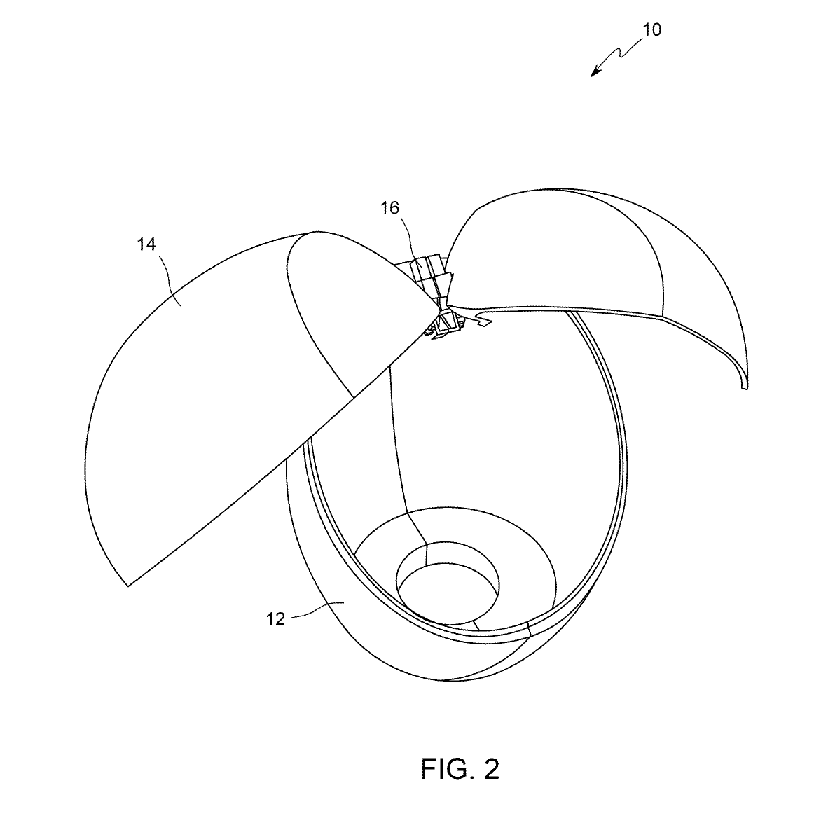

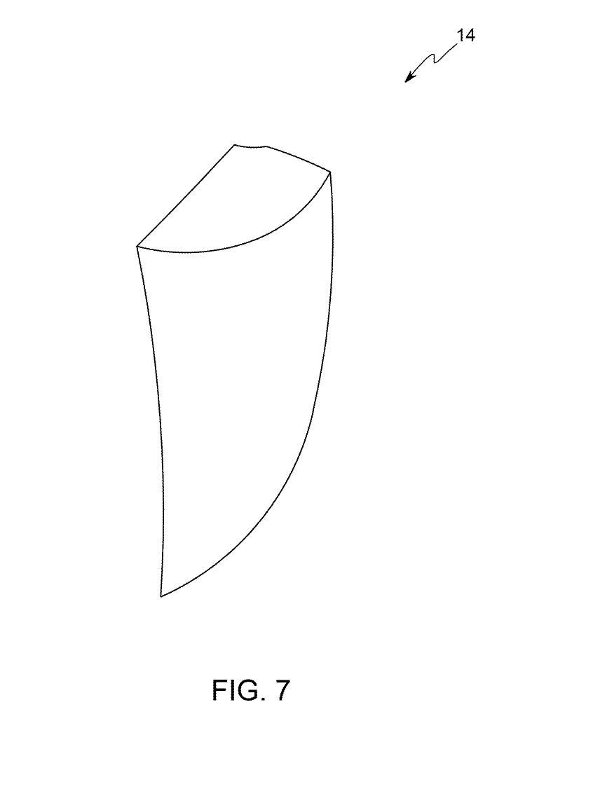

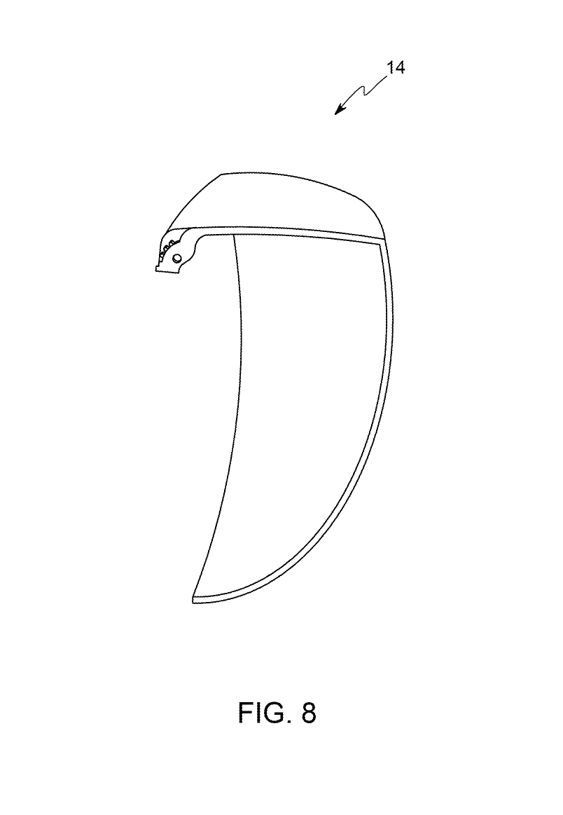

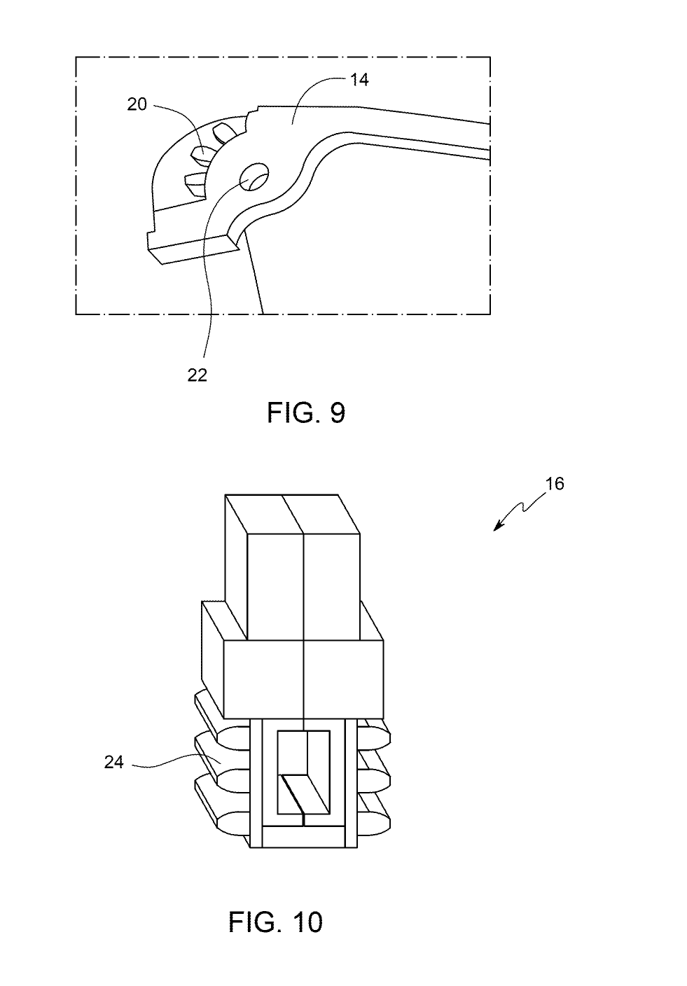

Referring to FIGS. 1, 2, and 7 through 9, each swivel door 14 comprises a substantially convexly-shaped exterior surface such that, both the swivel doors 14, as seen in FIG. 2, form a dome-shaped structure when are sealed together over the opening of the receptacle 12. As can be clearly seen in FIG. 9, on the inner side and towards the top inner corner (i.e., the corner facing the opposite swivel door) of each swivel door comprises an arc surface wherein, a plurality of gear teeth 20 outwardly extends from the arc surface. Further, an attachment hole 22 disposed on the inner side of the swivel door 14 such that, the distance between any point on the arc and the attachment hole 22 is same. The swivel door 14 is secured to the receptacle 12 as the extension rod 18 is received within the attachment hole 22 such that, the swivel door 14 rotates about the extension rod 18.

Referring to FIGS. 1, 2, 10 and 11, the slider member 16 comprises an elongate rectangular member comprising a plurality of slider teeth 24 extending from the each side thereof. The slider member 16 is vertically slidably disposed between the pair of extension rods 18 such that, the slider member 16 is movable between an upward lock position and a downward unlock position wherein, understanding of the terms upward lock and downward unlock positions will become apparent from the following body of text. Further, the slider member 16 is adapted to be biased towards to the downward unlock position by means of a spring-loaded mechanism.

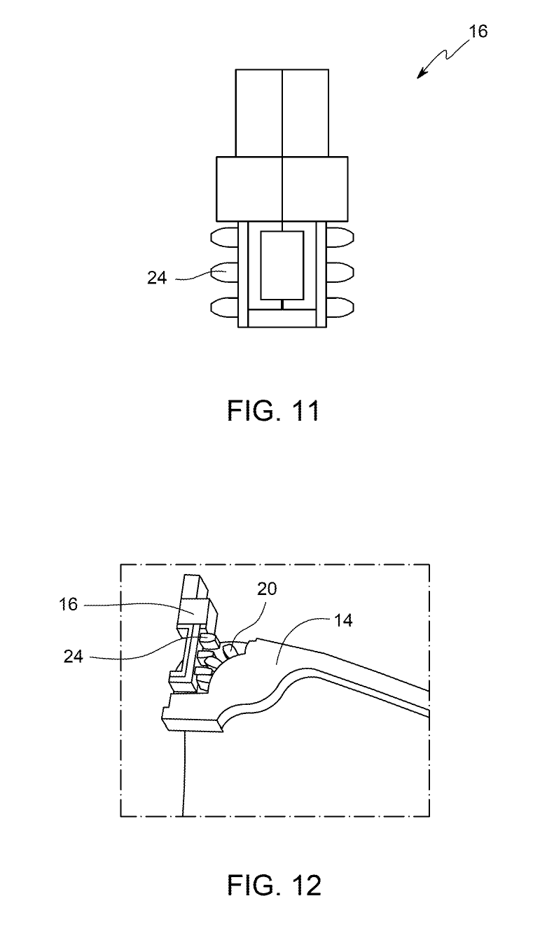

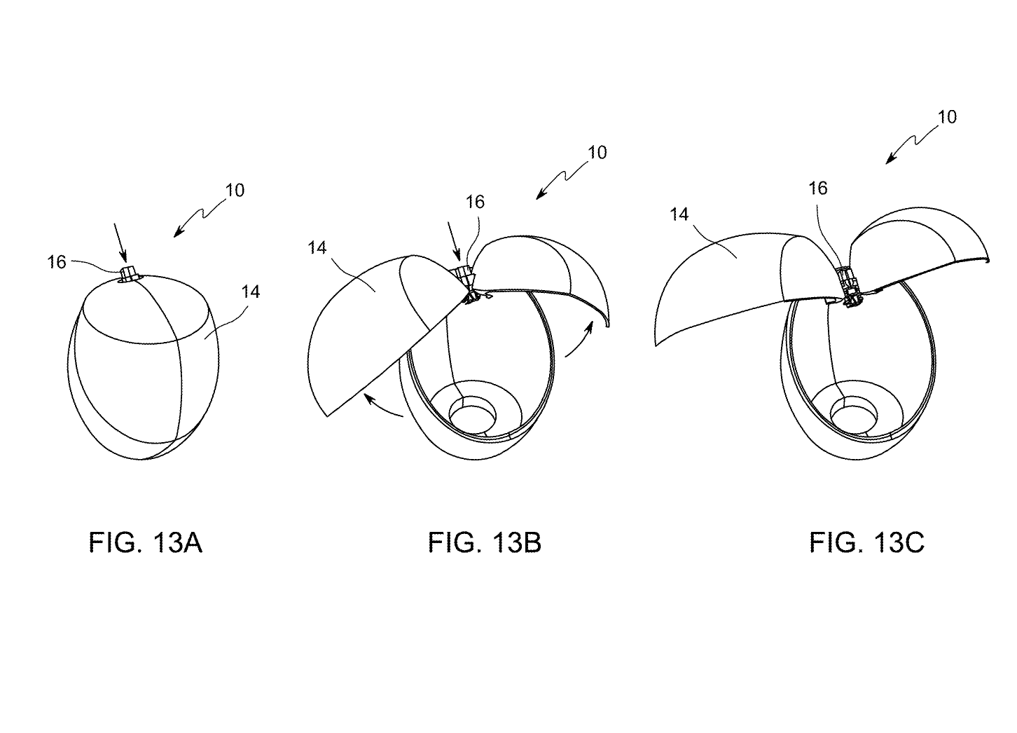

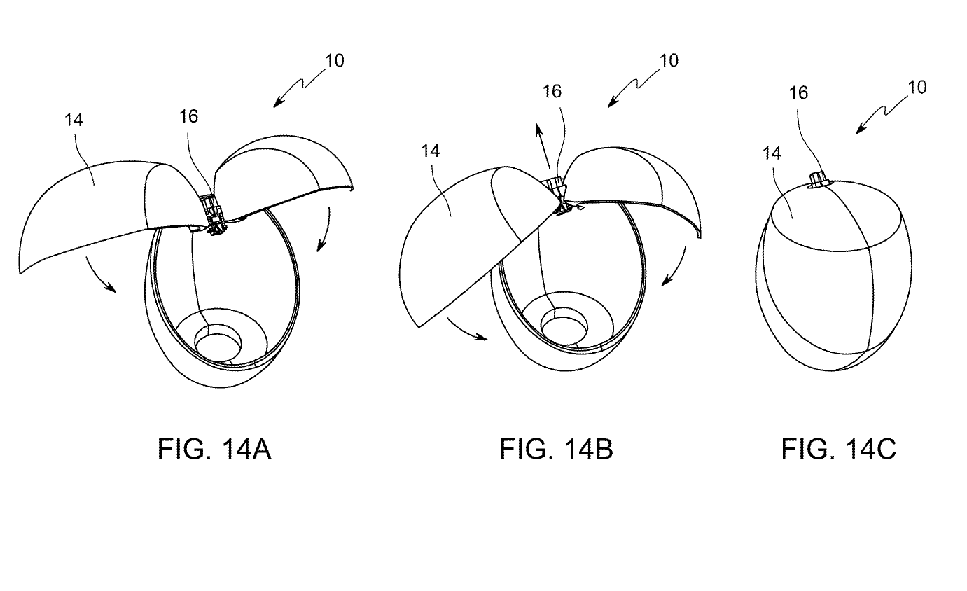

Referring to FIGS. 1, 2, 12, 13A through 13C, and 14A through 14C, the slider teeth 24 meshes with the gear teeth 20 as the pair of swivel doors 14 and the slider member 16 as assembled on the receptacle 12. The swivel doors 14 are snap-fitted to the receptacle 12 as the receptacle 12 is sealed by the swivel doors 14. In order to open the grill 10, as seen in FIGS. 13A through 13C, initially, the slider member 16 needs to be pressed downward so as to urge the doors out of the snap-fit or snap-lock. Once the swivel doors 14 come unsnapped, as mentioned earlier, as the slider member 16 is biased towards the downward unlock position, the swivel doors 14, by overcoming the weight thereof and friction between extension rods and the attachment hole, swivel upward automatically without any need for the slider member 16 to be pushed (or pressed) downward any further. The swivel door 14 is preferably lighter in weight so as to offer as least as possible resistance against the slider member 16. In order to close the grill 10, either one or both the swivel doors 14 are manually pushed down and snap-fitted to the receptacle 12 as shown in FIGS. 14A through 14C. As the swivel doors 14 are sealed, the outer edges of the swivel doors 14 abut the lining material so as to air-tightly seal the receptacle 12 with the swivel doors 14.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

What is claimed is:

1. A grill comprising:
(a) a receptacle comprising a pair of extension rods projecting outwardly therefrom;
(b) a pair of swivel doors for sealing the receptacle, the inner side of each swivel door comprising:
(i) an arc surface;
(ii) a plurality of gear teeth extending outwardly from the arc surface; and
(iii) an attachment hole for receiving an extension rod therewithin such that, the swivel door, while being secured to the receptacle, rotates about the extension rod; and
(c) a slider member vertically slidably secured to the receptacle between the pair of extension rods, the slider member comprising a plurality of slider teeth extending from each side thereof, the slider teeth on each side of the slider member is adapted to engage the gear teeth of a swivel door;
wherein, the downward movement of the slider member causes the swivel doors to rotate upwards thereby providing access into the receptacle.

2. The grill of claim 1 wherein, the receptacle is sealed by pulling at least one swivel door downward causing the slider member to move upwards.

3. The grill of claim 1 wherein, the rim of the opening of receptacle is obliquely oriented.

4. The grill of claim 4 wherein, the rim of the opening of the receptacle is at 45 degrees with respect to horizontal or vertical.

5. The grill of claim 4 wherein, each of the swivel doors is adapted to swivel in an oblique plane parallel to the plane of the rim.

6. The grill of claim 4 wherein, the each of the extension rods is perpendicular to oblique plane of the rim.

7. The grill of claim 1 wherein, the swivel doors when closed together make up a dome-shaped structure.

8. The grill of claim 1 wherein, the slider member is downwardly biased.

9. The grill of claim 8 wherein, the slider member is spring-loaded so as to be downwardly biased wherein, upon manually pressing the slider member downward till the swivel doors are urged out of the seal, the swivel doors automatically rotate upward so as to provide the access into the receptacle.

10. The grill of claim 1 wherein, the swivel doors are snap-fitted to the receptacle in order to seal the receptacle.

11. A grill comprising:
(a) a receptacle comprising a pair of extension rods projecting outwardly therefrom;
(b) a pair of swivel doors for sealing the receptacle, the inner side of each swivel door comprising:
(i) an arc surface;
(ii) a plurality of gear teeth extending outwardly from the arc surface; and
(iii) an attachment hole for receiving an extension rod therewithin such that, the swivel door, while being secured to the receptacle, rotates about the extension rod; and
(c) a slider member vertically slidably secured to the receptacle between the pair of extension rods, the slider member comprising a plurality of slider teeth extending from each side thereof, the slider teeth on each side of the slider member is adapted to engage the gear teeth of a swivel door;
wherein, the downward movement of the slider member causes the swivel doors to rotate upwards thereby providing access into the receptacle and wherein, manually pushing one of the swivel doors or both the swivel doors downward causes the receptacle to be sealed.
